(19) United States
(12) Patent Application Publication
(10) Pub. No.: US 2012/0058310 A1
(43) Pub. Date: Mar. 8, 2012

(54) METHODS FOR MAKING MICROREPLICATION TOOLS

(76) Inventors: Dale L. Ehnes, Cotati, CA (US); Alan B. Campbell, Santa Rosa, CA (US); Mark E. Gardiner, Santa Rosa, CA (US); Robert Lee Erwin, Hudson, WI (US)

(21) Appl. No.: 13/318,603

(22) PCT Filed: May 3, 2010
(86) PCT No.: PCT/US10/33351

§ 371 Date: Nov. 2, 2011

Related U.S. Application Data
(60) Provisional application No. 61/175,118, filed on May 4, 2009.

(51) Int. Cl. B23B 1/00; B32B 3/30

(52) U.S. Cl. 428/169; 82/1.11

(57) ABSTRACT

A method for cutting a pattern in a work piece (50), wherein the pattern includes adjacent features (52,53) separated by a pitch spacing P. The method includes providing a cutting tool assembly (74) having a first tool shank with a first cutting tip (22) to create a first feature (52) in the work piece (50) and a second tool shank with a second cutting tip (23) to create a second feature (53) in the work piece (50), wherein a distance Y between the first cutting tip and the second cutting tip is equal to nP, and wherein n is an odd integer greater than 1. The work piece is rotated (C) with respect to the cutting tool assembly (74), and the cutting tool is advanced along a lateral direction (B) with respect to the rotating work piece (50), wherein the cutting tool (74) is advanced along the lateral direction a distance of 2P for each rotation of the work piece (50).

### TECHNICAL FIELD

The present disclosure relates to methods for machining a work piece such as, for example, a microreplication tool. The present disclosure is also directed to microreplicated structures that can be made from these tools, such as, for example, a light directing film.

### BACKGROUND

Diamond machining techniques can be used to create a wide variety of work pieces, such as microreplication tools including casting belts, casting rollers, injection molds, extrusion or embossing tools, and the like. Microreplication tools are commonly used in extrusion processes, injection molding processes, embossing processes, casting processes, or the like, to create parts having microreplicated structures. Light directing films, abrasive films, adhesive films, mechanical fasteners having self-mating profiles, or any molded or extruded parts may include the microreplicated structures, which have dimensions less than approximately 1000 microns.

The process of creating a microreplication tool using a cutting tool assembly can be costly and time consuming. U.S. Published Patent Application No. 2004/0045419 (the '419 publication), incorporated herein by reference, describes cutting tool assemblies including multiple cutting tips, which can be used to machine microreplication tools or other work pieces. In particular, the multiple cutting tips of the cutting tool assembly can be used to create multiple grooves or other features in a microreplication tool during a single cutting pass of the assembly. A cutting tool assembly with multiple cutting tips can form multiple features in a single cutting pass, and such tools can reduce production time and/or create more complex patterns more rapidly than cutting tool assemblies with a single cutting tip. For example, if the cutting tool assembly includes two diamonds, the number of passes required to cut the grooves in the microreplication tool can be reduced by one-half.

The cutting tips are precisely formed to correspond to grooves or other features to be created in the microreplication tool. The cutting tips are precisely positioned in a mounting structure such that the tips are spaced apart from one another a distance equal to one or more pitch spacings of the grooves to be created in the microreplication tool.

In addition, the different diamond tips may define different features to be created in the microreplication tool. In that case, it is not necessary to use two different cutting tool assemblies to create two or more physically distinct features in the work piece. Such techniques may improve the quality of the microreplication tool and can reduce the time and costs associated with the creation of the microreplication tool, which in turn, may effectively reduce the costs associated with the ultimate creation of microreplicated articles.

### SUMMARY

The '419 publication describes fly cutting, plunge cutting, and thread cutting techniques that can be used to efficiently produce a microreplicated tool with a cutting tool assembly having multiple cutting tips. For each rotation of the work piece, the '419 publication teaches (FIG. 12) that the cutting tool be advanced a lateral distance equal to a single pitch spacing (P) between adjacent structures to be created in the work piece. In contrast, the fly, plunge and thread cutting methods described in the present disclosure require that, for each rotation of the work piece, a cutting tool assembly with cutting tips be advanced multiple pitch spacings. This provides enhanced cutting accuracy and reduces the number of passes required to complete the machining of the work piece.

For example, if the cutting tips of the cutting tool assembly are spaced apart a distance equal to nP, where n is an odd integer, the tool can be advanced a distance of 2P so the work piece can be completely machined in one cutting pass (also referred to herein as single start cutting). As another example, if the distance between the cutting tips is selected to be nP, wherein n is an even integer, the fly, plunge and thread cutting methods described in the present disclosure require that, for each rotation of the work piece, the cutting tool assembly be advanced a distance of 2(nP) so the work piece can be completely machined in two cutting passes (referred to herein as two start cutting).

Therefore, the present disclosure provides that selection of cutting tip spacing, tip shape and dimensions, and a lateral advancement per work piece rotation can further reduce machining time and facilitate more accurate formation of grooves and other structures with complex and varying shapes.

In one embodiment, the present disclosure is directed to a method for cutting a pattern in a work piece, wherein the pattern includes adjacent features separated by a pitch spacing P. The method includes providing a cutting tool assembly having a first tool shank with a first cutting tip to create a first feature in the work piece and a second tool shank with a second cutting tip to create a second feature in the work piece, wherein a distance Y between the first cutting tip and the second cutting tip is equal to nP, and wherein n is an odd integer greater than 1. The work piece is rotated with respect to the cutting tool assembly, and the cutting tool is advanced along a lateral direction with respect to the rotating work piece, wherein the cutting tool is advanced along the lateral direction a distance of 2P for each rotation of the work piece.

In another embodiment, the present disclosure is directed to a method for cutting a pattern in a work piece, wherein the pattern includes adjacent features separated by a pitch spacing P. The method includes providing a cutting tool assembly having a first tool shank with a first cutting tip to create a first feature in the work piece and a second tool shank with a second cutting tip to create a second feature in the work piece, wherein a distance Y between the first cutting tip and the second cutting tip is equal to nP, and wherein n is an even integer. The work piece is rotated with respect to the cutting tool assembly. Beginning at a starting position, the cutting tool is advanced along a lateral direction with respect to the rotating work piece, wherein the tool is advanced along the lateral direction a distance of 2Y for each rotation of the work piece. The cutting tool is returned to the starting position and advanced a distance P along the lateral direction to an offset starting position; and beginning at the offset starting position, the cutting tool is advanced along the lateral direction with respect to the rotating work piece, wherein the cutting tool is advanced a distance of 2Y for each rotation of the work piece.

In yet another embodiment, the present disclosure is directed to a method for cutting a pattern in a work piece, wherein the pattern includes adjacent features separated by a desired pitch spacing P and a maximum acceptable departure Δ from P. The method includes providing a cutting tool assembly having a first tool shank with a first cutting tip to create a first feature in the work piece and a second tool shank with a second cutting tip to create a second feature in the work piece. A distance Y=nP is established between the first and second cutting tips, wherein n is an integer greater than ε/Δ, and wherein ε is an accuracy in achieving a desired spacing between the first and second cutting tips. If the actual distance between the first and second cutting tips is equal to S, the work piece is rotated with respect to the cutting tool assembly, and the cutting tool is advanced along a lateral direction with respect to the rotating work piece, wherein the cutting tool is advanced along the lateral direction a distance of 2P′ for each rotation of the work piece, wherein P′=S/n.

In another embodiment, the present disclosure is directed to a light directing film, including a structured major surface with an array of rows of linear microstructures extending along a first direction. Each linear microstructure in the array includes a plurality of first regions with constant heights and a plurality of second regions with maximum heights greater than the constant heights of the plurality of first regions, wherein the second regions of any two linear microstructure n rows apart are in linear registration with each other but not with the second regions of the in between linear microstructures, n being greater than 2.

In another embodiment, the present disclosure is directed to a method for cutting a pattern in a work piece. The method includes providing a cutting tool assembly having a plurality of cutting tips, wherein the cutting tips have a non-constant height, wherein a distance between the cutting tips P is non-constant, and wherein the cutting tool assembly has a width Y. The work piece is rotated with respect to the cutting tool assembly, and advanced along a lateral direction with respect to the rotating work piece, wherein the cutting tool is advanced along the lateral direction a distance of Y for each rotation of the work piece.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is conceptual perspective view of an apparatus suitable for plunge or thread cutting machining processes for creating a microreplication tool;

FIG. 2 is a top view of a cutting tool apparatus that can be used in the plunge/thread cutting apparatus of FIG. 1.

FIGS. 3A-3F are schematic cross-sectional top views of a cutting tool cutting grooves into a work piece, and the resulting grooves and protrusions formed in the work piece.

FIGS. 4A-4H are schematic cross-sectional top views of a cutting tool cutting grooves into a work piece, and the resulting grooves and protrusions formed in the work piece.

FIGS. 5A-4F are schematic cross-sectional top views of a cutting tool cutting grooves into a work piece, and the resulting grooves and protrusions formed in the work piece.

FIGS. 6A-6C are schematic cross-sectional top views of a cutting tool cutting grooves into a work piece, and the resulting grooves and protrusions formed in the work piece.

FIGS. 7A-7B are top views of cutting tool apparatuses that can be used in the plunge/thread cutting apparatus of FIG. 1.

FIGS. 8-10 are top views of cutting tool apparatuses that can be used in the plunge/thread cutting apparatus of FIG. 1.

FIGS. 11A-11C are schematic perspective views of light directing films that can be made using work pieces machined using the plunge/thread cutting apparatus of FIG. 1.

FIG. 12A is a schematic cross-sectional view of a cutting tool than can be used in the plunge/thread cutting apparatus of FIG. 1.

FIGS. 12B-12C are schematic cross-sectional views of a work piece with grooves cut by the cutting tool of FIG. 12A.

FIG. 13A is a schematic cross-sectional view of a cutting tool than can be used in the plunge/thread cutting apparatus of FIG. 1.

FIG. 13B is a photograph of a work piece with grooves cut by the cutting tool of FIG. 13A.

Like reference symbols in the various drawings indicate like elements. The drawings in this application are not to scale.

### DETAILED DESCRIPTION

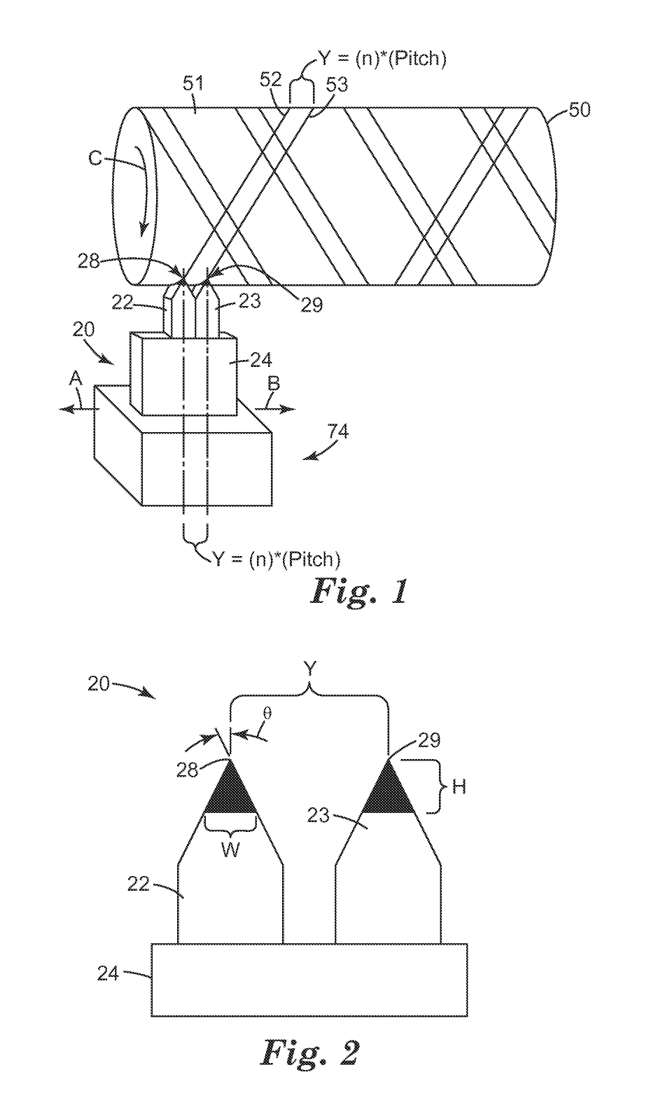

FIG. 1 illustrates a cutting tool assembly 20 including a mounting structure 24. The mounting structure 24 includes a first cutting tool shank 22 with a cutting tip 28, as well as a second cutting tool shank 23 with a cutting tip 29. While the cutting tool assembly shown in FIG. 1 includes two cutting tips, any number of cutting tool shanks may be mounted in the mounting structure 24. The cutting tips 28, 29 may have the same shape and size, or may be different shapes and sizes, to create a desired pattern of microstructures in a work piece. The work pieces described in this disclosure are microreplication tools such as the tool 50 shown in FIG. 1, but the present methods can be used with any work piece machineable by at least one of fly, plunge and thread cutting. In FIG. 1, the microreplication tool 50 is a casting roll, although other microreplication tools such as casting belts, injection molds, extrusion or embossing tools, or other work pieces could also be created using cutting tool assembly 20.

The cutting tool assembly 20 is secured in a tooling machine 74 that positions the cutting tool assembly 20 relative to the microreplication tool 50. The tooling machine 74 moves the cutting tool assembly 20 in a lateral direction (as illustrated by the arrows A and B) relative to the microreplication tool 50. At the same time, the microreplication tool 50 is rotated about an axis in a direction indicated by the arrow C. The tooling machine 74 may contact the cutting tool assembly 20 with the rotating microreplication tool 50 using plunge cutting, thread cutting, fly cutting techniques and/or combinations thereof (only the thread cutting techniques will be described in detail herein) to cut grooves in a surface 51 of the microreplication tool 50. As the cutting tips 28, 29 machine the microreplication tool 50, a corresponding pattern of grooves and protrusions are formed in the surface 51 thereof. In addition, a fast tool servo (not shown in FIG. 1) can optionally be used between the cutting tool assembly 20 and the machine tool 74. For example, the fast tool servo can vibrate the cutting tool assembly 20, which creates particular microstructures in the surface 51. When a suitable material is cast or extruded against the tool 50, a microstructured article is formed having protruding structures corresponding to the grooves formed in the surface 51 of the tool 50 by the cutting tips 28, 29.

The multiple tip cutting tool 20 is shown in more detail in FIG. 2, and each cutting tip may be described by one or more variables including, for example, the cutting height (H), the cutting width (W), and tip angle (θ). The cutting height (H) defines the maximum depth that a cutting tip can cut in a work piece, and may also be referred to as the cutting depth. When an article is cast against the tool, the cutting depth corresponds to the height (from base to peak) of the structures in the article. The cutting width (W) may be defined as the average cutting width, or as labeled in FIG. 2, the maximum cutting width of a cutting tip. When an article is cast against the tool, the cutting width corresponds to the width at the base of the structures in the article. For example, the height (H) and/or the width (W) can be formed to be less than approximately 500 microns, less than approximately 200 microns, less than approximately 100 microns, less than approximately 50 microns, less than approximately 10 microns, less than approximately 1.0 micron, or less than approximately 0.1 micron.

Another quantity that can be used to define the size of a cutting tip 28, 29 is the aspect ratio, the ratio of height (H) to width (W). The aspect ratio may be defined to be greater than approximately 1:5, greater than approximately 1:2, greater than approximately 1:1, greater than approximately 2:1, or greater than approximately 5:1.

The variable (Y) in FIG. 2 refers to the nominal distance between the adjacent cutting tips 28 and 29 in the cutting tool 20, and is defined herein in terms of an integer number (n) of pitch spacings (P). The term “pitch” (P) in this disclosure refers to the distance between two adjacent features to be created in a work piece, such as the adjacent grooves 52, 53 created by the respective cutting tips 28, 29 in the surface 51 of the microreplication tool 50 of FIG. 1. As explained in more detail below, in this disclosure it will be assumed that n is an integer greater than or equal to 1, which means that the cutting tips 28, 29 in the cutting tool 20 are separated by more than one pitch spacing P.

Typically, the cutting tips 28, 29 can be positioned relative to one another in the mounting structure 24 within a tolerance of less than 10 microns, or less than 1 micron, or even on the order of 0.5 microns. Such precision placement may be required to effectively create microreplication tools for the manufacture of optical films, adhesive films, abrasive films, mechanical fasteners, or the like. Depending on the dimensions of the microreplication tool to be created, the pitch spacing P of adjacent features on the tool may be less than approximately 5000 microns, less than approximately 1000 microns, less than approximately 500 microns, less than approximately 200 microns, less than approximately 100 microns, less than approximately 50 microns, less than approximately 10 microns, less than approximately 5 microns, less than approximately 1 micron, and may approach the tolerance of the 0.5 micron spacing of the tips 28, 29.

In some embodiments one of the cutting tips 28, 29 can be fixed and the other cutting tip can be moved until the cutting tips 28, 29 have the desired spacing. For example, referring to FIG. 2, the shank 22 can be fixed in the mounting structure 24 to precisely locate the cutting tip 28, and then the shank 23 can be moved in the mounting structure 24 until the cutting tip 29 is in the desired location. The shanks 22, 23 can be moved in the mounting structure 24 by, for example, tapping, shimming, a flexure, or a separate positioning stage. In an alternative embodiment not shown in FIG. 2, the cutting tips 28, 29 can be provided on a single shank, or two cutting tips can be milled in a single crystal.

For example, diamond tips created by focused ion beam milling processes can achieve the various heights, widths, pitches and aspect ratios described above. Focused ion beam milling refers to a process in which ions, such as gallium ions, are accelerated toward the diamond to mill away atoms of the diamond (sometimes referred to as ablation). The acceleration of gallium ions may remove atoms from the diamond on an atom by atom basis. Less expensive techniques such as lapping or grinding may also be used alone or in combination with ion beam milling to form the diamond tip and/or other portions of the cutting tips 28, 29 in FIG. 2. Lapping refers to a process of removing material from the diamond using a loose abrasive, whereas grinding refers to a process in which material is removed from the diamond using an abrasive that is fixed in a medium or substrate.

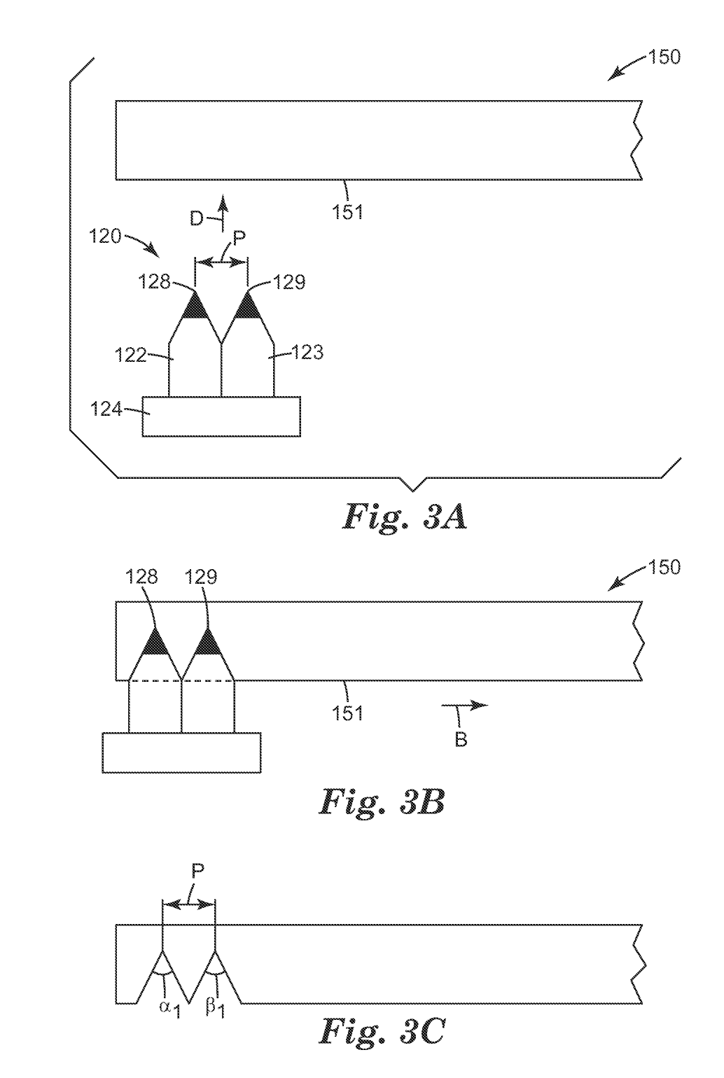

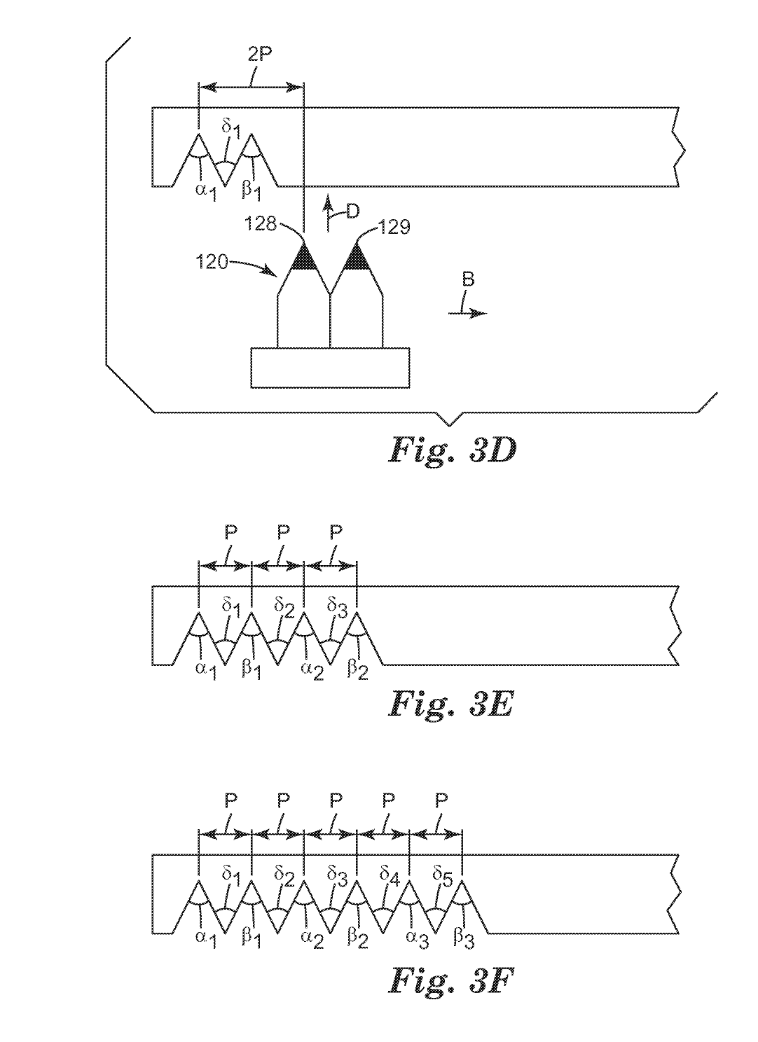

Referring to FIG. 3A and FIG. 3B, a cutting tool 120 includes a tool mounting structure 124 with tool shanks 122, 123 and cutting tips 128, 129. The cutting tool 120 can be moved into position along the direction of arrow D so that cutting tips 128, 129 engage a surface 151 of a work piece 150 and machine grooves of a selected depth in the surface 151. In the tool 120, the cutting tips 128, 129 are separated by a distance of one pitch distance P, i.e. n=1 in the formula Y=nP, and Y=P, which means that the distance Y between the cutting tips 28, 29 in the cutting tool 20 would be equal to the pitch of features in a work piece, i.e. Y=P. As shown in FIG. 3C, during the first revolution of the work piece 150, cutting tool 120 is moved laterally along the direction B such that the first cutting tip 128 cuts a first groove α1 and the second cutting tip 129 cuts a second adjacent groove β1. The troughs of the grooves α1 and β1 are separated by a distance P. In FIG. 3D, during the second rotation of the work piece 150, the tool 120 is again moved a lateral distance of 2P along the direction B so that the first cutting tip 128 cuts a groove α2 in the surface 151 and the second cutting tip 129 cuts a groove β2 (FIG. 3E). Again, the troughs of the grooves α2 and β2 are separated by a distance P. During the third rotation of the work piece 150, the tool 120 is again moved a lateral distance of 2P along direction B such that the first cutting tip 128 cuts a groove α3 in the surface 151 and the second cutting tip 129 cuts a groove β3 (FIG. 3F). Again, the troughs of the grooves α3 and β3 are separated by a distance P. The movement of the cutting tool 120 in lateral increments of 2P per revolution of the work piece 150 continues until a desired portion of (or substantially the entire surface) 151 is fully machined.

In view of the above, if the distance Y between the cutting tips 128, 129 is selected to be equal to nP, where n is an odd integer, and the tool is advanced a distance of 2P during each rotation of the work piece, then only one cutting pass is required to fully process the surface 151 of the work piece 150.

The method described in FIG. 3A-3F is referred to as a one-start or a one pass process, which in this application means the cutting tool moves from its starting position in only one lateral direction with respect to the work piece to continuously machine a desired portion of the surface of the work piece in a single pass. In some embodiments the substantially the entire surface is machined in a single pass, and in other embodiments only partial machining of the surface is required.

In this application multi-start or multi-pass processes refer to cutting methods in which the cutting tool takes a first cutting pass to machine a first portion of the work piece, and a second cutting pass to machine a second portion of the work piece.

In the first cutting pass, the cutting tool moves from a first starting position along a first lateral direction with respect to the work piece to partially machine a first portion of the surface of the work piece. Following the first cutting pass, the surface of the work piece includes a first pattern of grooves. After the first cutting pass is complete, the cutting tool is moved along a second lateral direction, opposite to the first lateral direction, to a second starting position. During this “return” pass, the cutting tool does not machine the work piece. The second starting position can be the same as the first starting position, or different from the first starting position.

After the cutting tool is placed at the second starting position, the cutting tool makes the second cutting pass to machine a second portion of the work piece. The second portion of the work piece may be the same as the first portion, or may be different from the first portion. From the second starting position the cutting tool is moved along the first lateral direction until the work piece is machined.

For example, in a multi start process, in some embodiments the second starting position is different from the first starting position, and the cutting tool forms a second pattern of grooves in the work piece, which are different from the first pattern of grooves formed in the first cutting pass.

In another example, in multi pass processes, in some embodiments the cutting tool returns to a second position that is the same as the first position. In these embodiments, the cutting tool follows the first pattern of grooves formed in the first cutting pass. However, in the second cutting pass the cutting tool can be moved deeper into the work piece to remove additional material from the surface of the work piece. The second cutting can provide better feature fidelity (tearing or deforming can occur for some structures if the amount of material removed from the surface of the work piece in the first cutting pass is too aggressive), and/or may add additional structural features to the grooves formed in the first cutting pass.

Typically, a one start process provides more accurate groove and peak formation than a multi-start process. Cutting conditions such as humidity, temperature and the like can change between multiple cutting passes, which can adversely affect the accuracy of the grooves machined in the work piece. Multi-start cutting also requires that the cutting tool be repositioned at least once with respect to the work piece, which can result in less accurate groove placement than single start methods. Single start cutting is also simply faster and easier than multi-start cutting, and is preferred to keep tooling costs to a minimum.

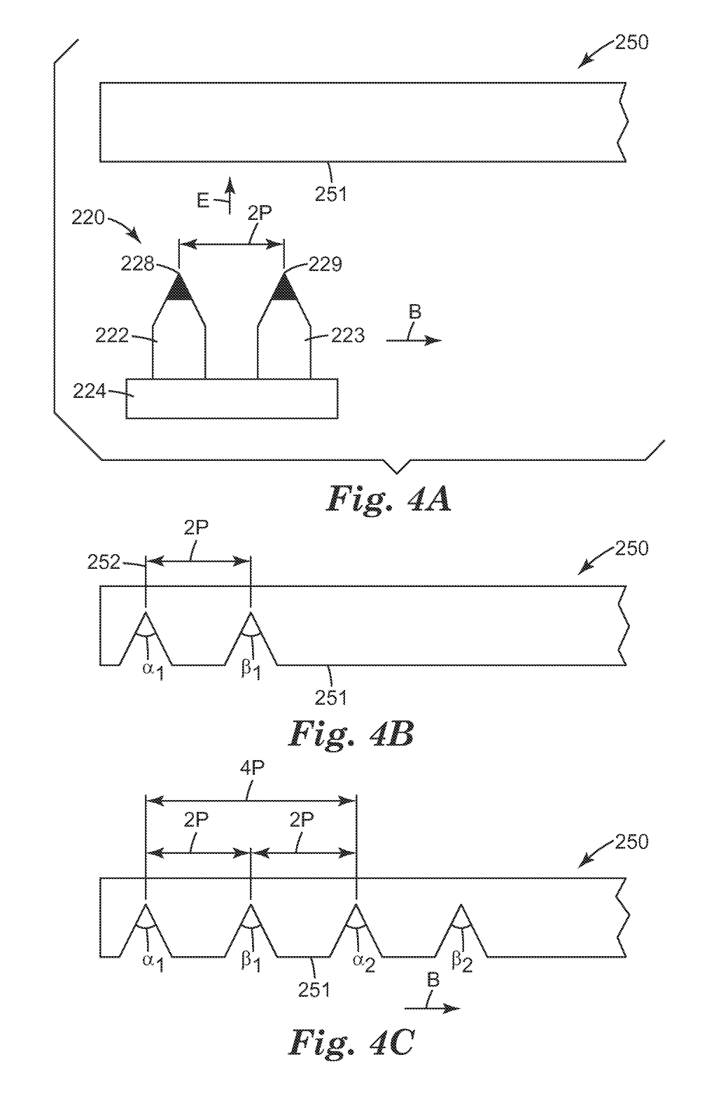

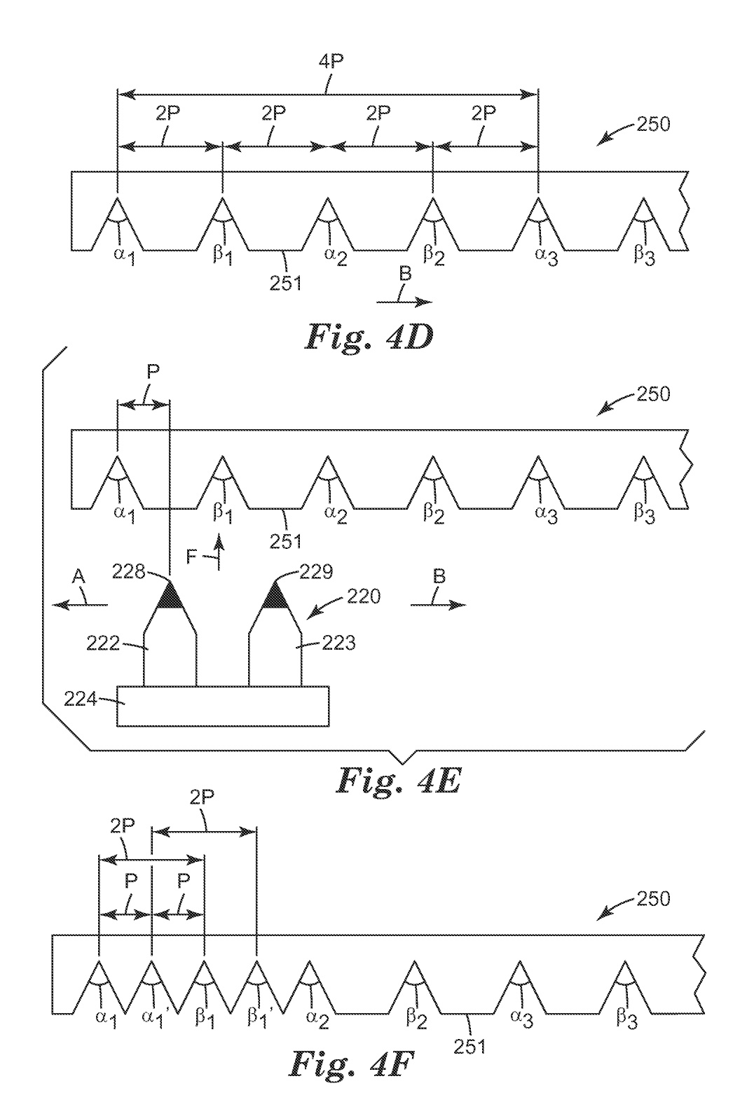

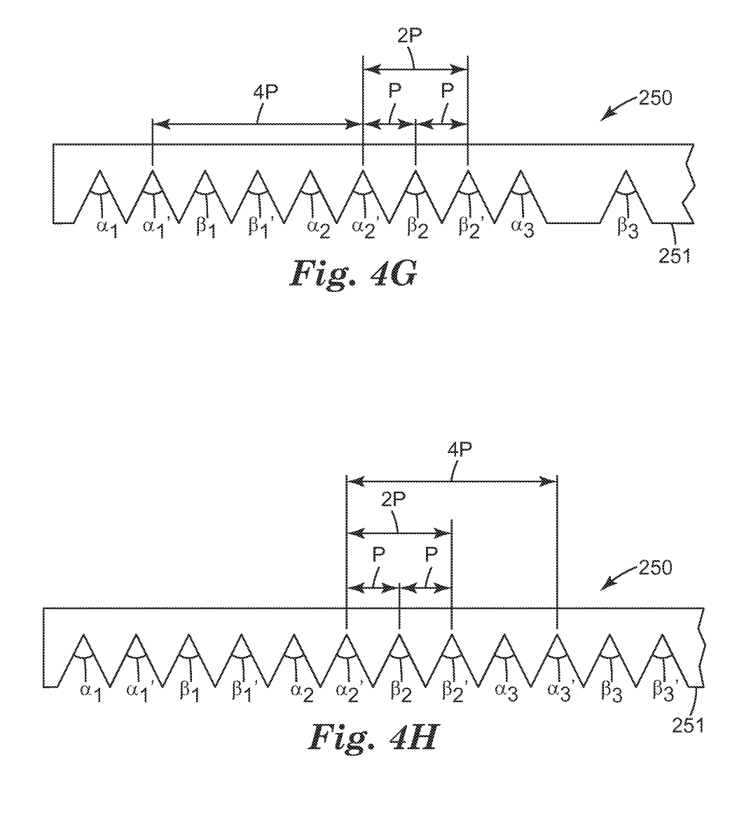

Referring to FIG. 4A and FIG. 4B, a cutting tool 220 includes a tool mounting structure 224 with tool shanks 222, 223 and cutting tips 228, 229. The cutting tool 220 is moved in the direction of arrow E so cutting tips 228, 229 cut into a surface 251 of a work piece 250. In the tool 220, the cutting tips 228, 229 are separated by a distance of two pitches P, i.e. n=2 in the formula Y=nP, and Y=2P. As shown in FIG. 3B, during a first revolution of the work piece 250, tool 220 moves laterally along the directions B, beginning at a starting point 252, such that the first cutting tip 228 cuts a first groove α1 in the work piece 250 and the second cutting tip 229 cuts a second adjacent groove β1. The troughs of the grooves α1 and β1 are separated by a distance 2P. During the second rotation of the work piece 250, the tool 220 is moved a lateral distance of 4P along the direction B to cut the next set of grooves in the surface 251, and the first cutting tip 228 cuts a groove α2 and the second cutting tip 229 cuts a groove β2 (FIG. 4C). Again, the troughs of the grooves α2 and β2 are separated by a distance 2P. During a third rotation of the work piece 250, the tool 220 is again moved a lateral distance along direction B of 4P, and the first cutting tip 228 cuts a groove α3 in the surface 251 and the second cutting tip 229 cuts a groove β3 (FIG. 4D). The troughs of the grooves α3 and β3 are separated by a distance 2P. The movement of the cutting tool 220 in lateral increments along direction B of 4P per revolution of the work piece 250 continues until the cutting tool 220 reaches an end of the surface 251 (not shown in FIG. 4D).

Referring to FIG. 4E, the tool 220 is then moved laterally back along direction A to a second cutting starting point 254 offset a distance of one pitch P from the original cutting starting point 252. As shown in FIG. 4F, during the first rotation of the work piece 250 following the second start, the tool 220 moves toward the surface 251 along the direction of arrow F and the first cutting tip 228 cuts a first groove α1′ and a second groove β1′ in the surface 251, and the trough of each groove is separated by a distance 2P. In addition, the trough of groove α1′ is a distance P from the trough of adjacent groove α1. Referring to FIG. 4G, during the second rotation of the work piece 250 the tool 220 is again moved a distance 4P to make a second cut and form grooves α2′ and β2′. The trough of grooves α2′ and β2′ are a distance 2P from each other, and a distance P from grooves α2 and β2, respectively. As shown in FIG. 4H, during the third rotation of the work piece 250 the tool 220 is again moved a distance 4P to make a third cut and form grooves α3′ and β3′. The trough of grooves α3′ and β3′ are a distance 2P from each other, and a distance P from grooves α3 and β3, respectively. This procedure continues until the surface 251 is fully machined.

In view of the above, if the distance Y between the cutting tips 228, 229 is selected to be equal to nP, where n is an even integer, and the tool is advanced a distance of 2nP during each rotation of the work piece, then two cutting starts can be used to fully process the surface 251 of the work piece 250.

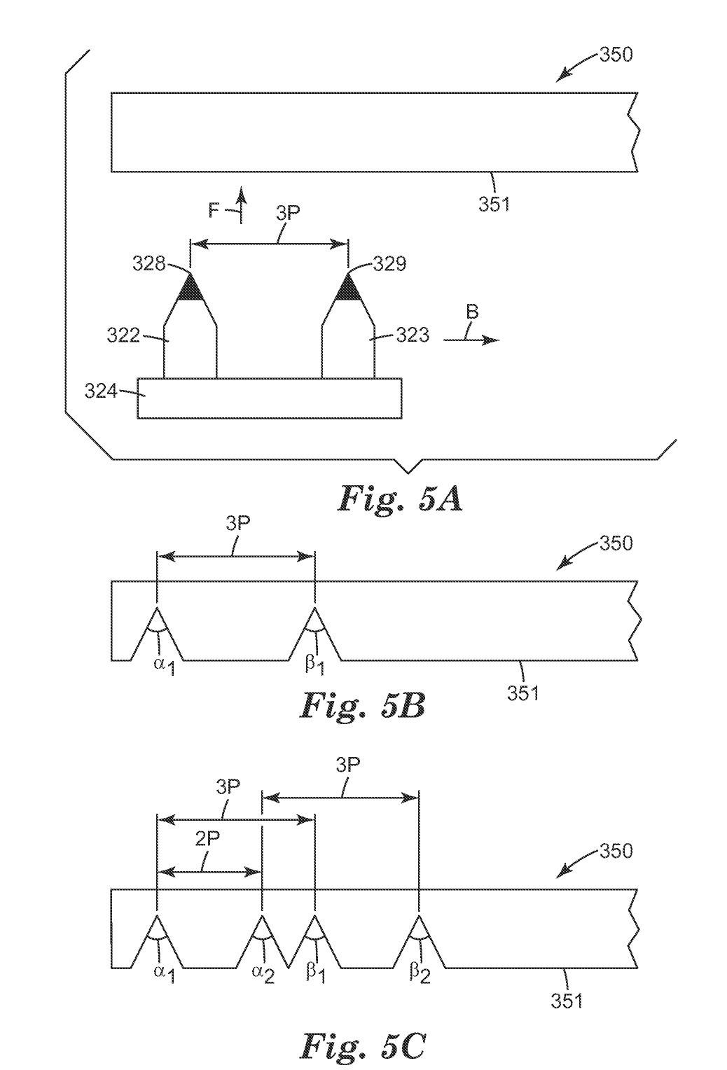

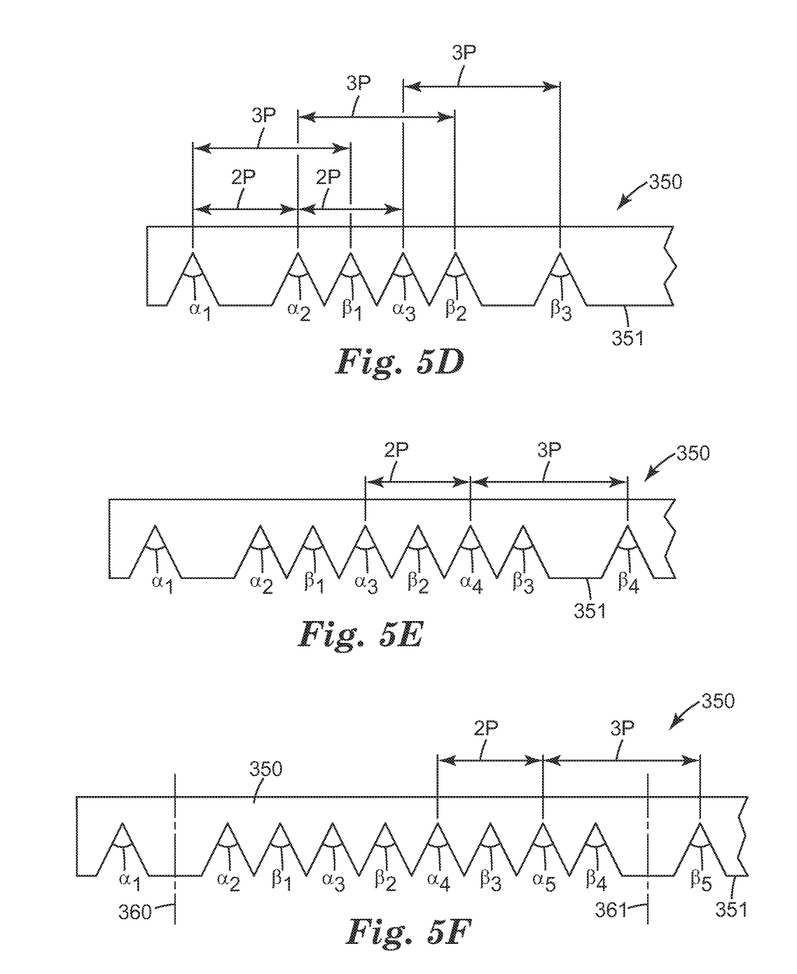

Referring to FIG. 5A and FIG. 5B, a cutting tool 320 includes a tool mounting structure 324 with tool shanks 322, 323 and cutting tips 328, 329. The cutting tool 320 is moved laterally along the direction B (FIG. 1) and in the direction of arrow G so that cutting tips 328, 329 cut into a surface 351 of a rotating work piece 350. In the tool 320, the cutting tips 328, 329 are separated by a distance of three pitches P, i.e. n=3 in the formula Y=nP, and Y=3P. As shown in FIG. 5B, during the first revolution of the work piece 350, the first cutting tip 328 cuts a first groove α1 and the second cutting tip 329 cuts a second groove β1. The troughs of the grooves α1 and β1 are separated by a distance 3P. During the second revolution of the work piece 350, the tool 320 is moved a lateral distance of 2P along the direction B to cut the next set of grooves in the surface 351, and the first cutting tip 328 cuts a groove α2 in the surface 351 and the second cutting tip 329 cuts a groove β2 (FIG. 5C). Again, the troughs of the grooves α2 and β2 are separated by a distance 3P. During the third revolution of the work piece 350, the tool 320 is again moved a lateral distance along direction B a distance 2P, and the first cutting tip 328 cuts a groove α3 in the surface 351 and the second cutting tip 329 cuts a groove β3 (FIG. 5D). Again, the troughs of the grooves α3 and β3 are separated by a distance 3P. During the fourth revolution of the work piece 350, as shown in FIG. 5E, tool 350 is moved a lateral distance in direction B of 2P, while the first cutting tip 328 cuts a groove α4 in the surface 351 and the second cutting tip 329 cuts a groove β4 in the surface 351. Again, the troughs of the grooves α4 and β4 are separated by a distance 3P. The movement of the cutting tool 320 in lateral increments along direction B of 2P per revolution of the work piece 350 continues, forming grooves α5 and β5, which are separated by a distance of 3P, until the cutting tool 320 until the surface 351 is fully machined. After the final cut, the work piece 350 may be trimmed at the lines 360, 361 to form the final finished microreplication tool.

To make a microreplication tool with a pitch P between adjacent grooves using a single start, a cutting tool having dual cutting tips and a cutting tip spacing Y=nP, where n is an odd integer greater than 1, can be selected. The cutting tool should be advanced a distance of 2P during each revolution of the rotating work piece.

The work pieces above can be used as a microreplication tool to make a microreplicated article such as, for example, an optical film. To ensure that the optical film does not create unwanted optical effects (e.g. Moire patterns, wet-out and the like) when placed adjacent an optical device such as LCD, it is desirable to make accurate structures in the optical film. To make precise patterns of structures in the optical film, it is important to make the optical film with a microreplication tool having accurate groove patterns. If it is desired to make highly accurate groove patterns in a work piece, in which the pitch (P) between grooves is precisely controlled, the distance between the dual cutting tips, Y, of a cutting tool used to make the microreplication tool should also be precisely controlled. For example, assume that the desired pattern in the work piece includes adjacent features separated by a pitch spacing P and a maximum acceptable departure ±Δ from P. Assume that a dual tip cutting tool is to be used to make the pattern, so a distance Y=nP between the first and second cutting tips should be set, wherein n is an integer greater than ε/Δ, wherein ε is the accuracy in achieving the desired spacing between the first and second cutting tips. If the actual distance between the first and second cutting tips is S, to make a work piece with grooves of pitch P the cutting tool should be advanced along a lateral direction with respect to the rotating work piece a distance of 2P′ for each rotation of the work piece, wherein P′=S/n.

For example, assume that the desired pitch (P) in the work piece is 50 μm, with a maximum variation (Δ) in P of ±0.1 μm. Assume the error in the distance Y=nP between the dual cutting tips of the cutting tool, ε, is 10 μm. Therefore, n should be greater ε/Δ, or 1 μm/0.1 μm, or greater than 100. If n is selected to be =111, the actual spacing between the dual cutting tips, S, is (111)(50 μm)=5550 μm. Since S is actually about 5560 μm, the actual pitch P′ should be selected to be 5560 μm/111 or 50.09 μm. With the cutting tip spacing of 5560 μm, the cutting tool should be advanced a lateral distance of 2P′ for each rotation of the work piece to provide an array of prismatic structures on the surface of the work piece with the same height, the same base width, and the symmetrical side walls.

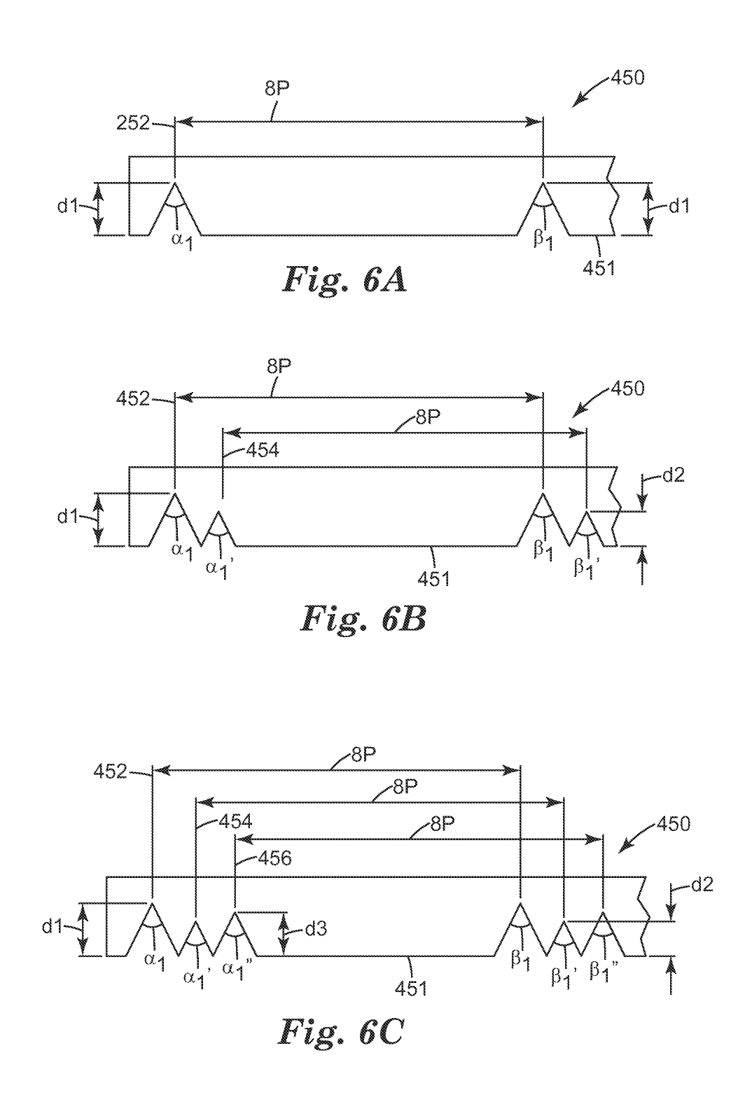

The fly, plunge and thread cutting methods described above provide great flexibility in producing microreplicated tools. For example, “wet-out” can occur in an optical display when a microreplicated surface of a light directing film contacts a surface of another film, causing a variation in light intensity across the display surface area. To reduce wet-out effects, a dual tip cutting tool may be used to cut grooves in a surface 451 of a work piece 450 as shown in FIG. 6A-C. The tool (not shown) has two cutting tips a distance 8P apart, and from a first starting position 452 cuts grooves α1 and β1, each having a depth d1, during a first rotation of the work piece 450. During the second rotation of the work piece 450, the tool is advanced laterally a distance 2(8P)=16P to cut grooves α2 and β2, each also having a depth d1 (not shown in FIG. 6A). Referring to FIG. 6B, after repeating this sequence n times as necessary to reach the end of the surface 451, the tool is returned to a second starting position 454 offset a distance P from the first starting position 452. During the first subsequent rotation of the work piece 450, the tool cuts grooves α1′ and β1′, each 8P apart and having a depth of d2<d1. During the second rotation of the work piece 450, the tool is advanced laterally a distance 2(8P)=16P to cut grooves α2′ and β2′, each also having a depth d2<d1 (not shown in FIG. 6B). Referring to FIG. 6C, after repeating this sequence n times as necessary to reach the end of the surface 451, the tool is returned to a third starting position 456 offset a distance P from the second starting position 454. During the first subsequent rotation of the work piece 450, the tool cuts grooves α1″ and β1″, each 8P apart and having a depth of d2<d3<d1. During the second rotation of the work piece 450, the tool is advanced laterally a distance 2(8P)=16P to cut grooves α2″ and β2″, each also having a depth d2<d3<d1 (not shown in FIG. 6C). The tool may then be returned to a fourth starting position offset a distance P from groove α1″ and the process may continue n times as necessary to fully machine the surface 451. The resulting tool has grooves αt varying depths d2<d3<d1, and this varying depth can be used to reduce wet-out effects when an optical film made from the tool is used in an optical display.

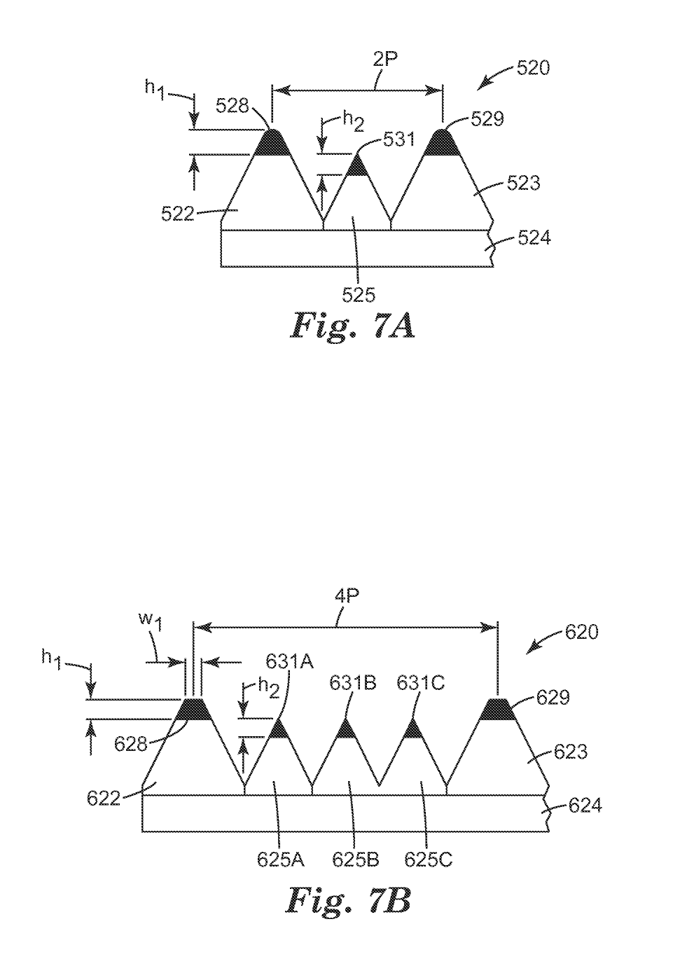

In another example shown in FIG. 7A, a portion of a cutting tool 520 includes a tool mounting structure 524 with tool shanks 522, 523 and 525. Each tool shank 522, 523, 525 includes a cutting tip 528, 529 and 531, respectively. The cutting tips 528, 529 each have a height h1, which will create grooves with an identical cutting depth d1 when the cutting tips 528, 529 engage a surface of a work piece (not shown in FIG. 7A). The cutting tips 528, 529 are rounded, which will machine a rounded trough in every groove of depth d1 in the work piece. In the cutting tool 520, the cutting tips 528, 529 are separated by a distance of two pitches P, i.e. n=2 in the formula Y=nP, and Y=2P. Thus, the rounded trough grooves of depth d1 in the work piece will be separated by a distance 2P. The cutting tip 531 has a height h2, which is less than h1, which will create grooves with an identical cutting depth h2 when the cutting tip 531 engages a surface of a work piece. The cutting tip 531 is pointed, which will machine a V-shaped trough in every groove of depth d2 in the work piece. In the cutting tool 520, the cutting tip 531 is separated by a distance of two pitches P, i.e. n=2 in the formula Y=nP, and Y=2P. Thus, the V-shaped trough grooves of depth d2 in the work piece will also be separated by a distance 2P.

In use, the tool 520 will be advanced a distance of 2(2P)=4P for each revolution of the work piece, and the resulting groove pattern will include rounded trough grooves with a depth d1 a distance 2P apart, each separated by a V-shaped groove with a depth d2. The V-shaped grooves will also be separated by a distance 2P. Optical films including structural patterns of ribs corresponding to this groove pattern have excellent resistance to scratching.

In yet another example shown in FIG. 7B, a portion of a cutting tool 620 includes a tool mounting structure 624 with tool shanks 622, 623 and 625A-C. Each tool shank 622, 623, 625 includes a cutting tip 628, 629 and 631A-C, respectively. The cutting tips 628, 629 each have a height h1, which will create grooves with an identical cutting depth d1 when the cutting tips 628, 629 engage a surface of a work piece (not shown in FIG. 7B). The cutting tips 628, 629 include a flat tip a distance d3 across, which will machine a flat trough a distance d3 wide at the bottom of every groove of depth d1 in the work piece. In the cutting tool 620, the cutting tips 628, 629 are separated by a distance of 4 pitches P, i.e. n=4 in the formula Y=nP, and Y 4P. Thus, the rounded trough grooves of depth d1 in the work piece will be separated by a distance 4P. The cutting tips 631A-C have a height h2, which is less than h1, which will create grooves with an identical cutting depth h2 when the cutting tips 631A-C engage a surface of a work piece. The cutting tips 631A-C are pointed, which will machine a V-shaped trough in every groove of depth d2 in the work piece. In the cutting tool 620, the cutting tips 631A-C are separated by a distance of one pitch P, i.e. n=1 in the formula Y=nP, and Y=P. Thus, the V-shaped trough grooves of depth d2 in the work piece will also be separated by a distance P.

In use, the tool 620 will be advanced a distance of 2(4P)=8P for each revolution of the work piece, and the resulting groove pattern will include flat trough grooves with a depth d1 a distance 4P apart, each separated by three V-shaped grooves with a depth d2. The V-shaped grooves will be separated by a distance P. For example, if a first optical film is formed using the tool shown in FIG. 7B, an adhesive may be applied on the ribs created by the cutting tips 628, 629. A second optical film with the same or a similar groove pattern may then be applied on the first optical film, with the longitudinal axes of the grooves in the second optical film positioned orthogonal to the longitudinal axes of the grooves in the first optical film. The resulting laminated structure may then be placed in an optical display device.

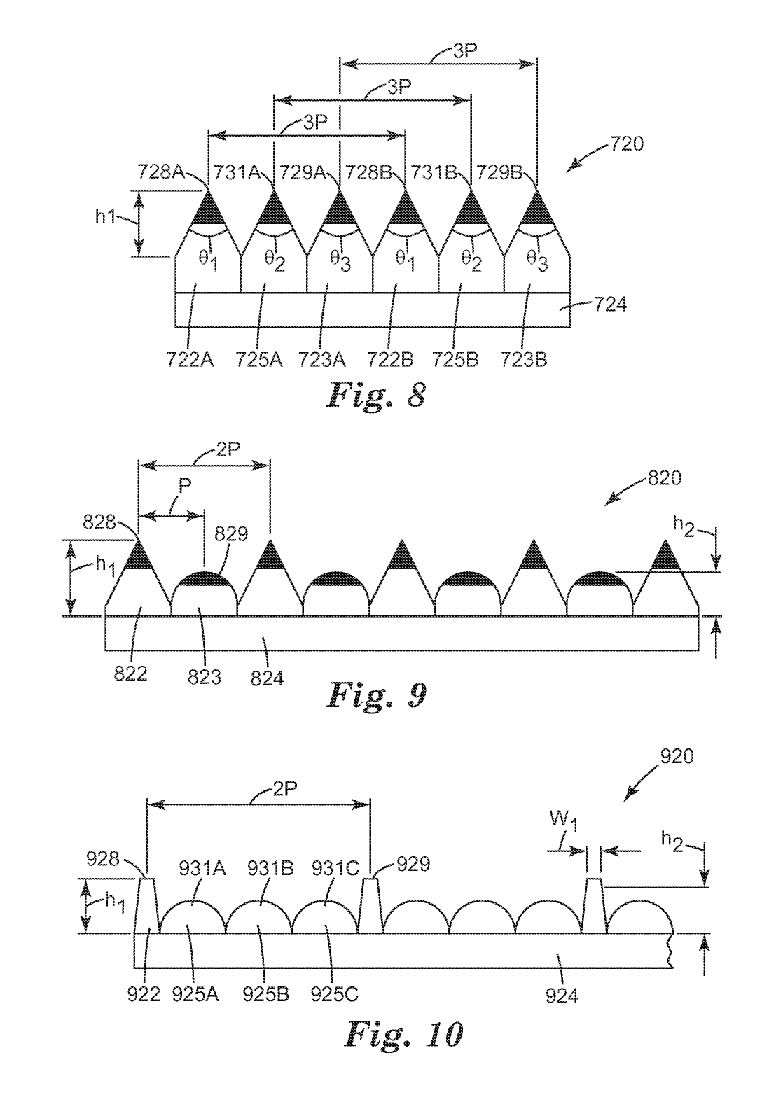

In yet another example shown in FIG. 8, a portion of a cutting tool 720 includes a tool mounting structure 724 with tool shanks 722A-B, 723A-B and 725A-B. Each tool shank 722A-B, 723A-B, 725A-B includes a cutting tip 728A-B, 729A-B and 731A-B, respectively. All the cutting tips have a height h1, which will create grooves with an identical cutting depth d1 when the cutting tips engage a surface of a work piece (not shown in FIG. 8). The cutting tips 728A-B have an included angle θ1, the cutting tips 731A-B have an included angle θ2, and the cutting tips 729A-B have an included angle θ3, and each of θ1, θ2, and θ3 is different. Each cutting tip will machine a generally V-shaped groove in the work piece, but each groove will have a slightly different angle. In the cutting tool 720, the cutting tips 728A-B, 729A-B and 731A-B are each separated by a distance of 3 pitches P, i.e. n=3 in the formula Y=nP, and Y=3P.

In use, to provide one start cutting the tool 720 will be advanced a distance of 2P for each revolution of the work piece, and the resulting groove pattern will include sets of three grooves, each P apart and having different included V-angles. Every third groove will have the same included angle.

In another example shown in FIG. 9, a portion of a cutting tool 820 includes a tool mounting structure 824 with tool shanks 822 and 823. Each tool shank 822, 823 includes a cutting tip 828, 829, respectively. The cutting tips 828 each have a height h1, which will create grooves with an identical cutting depth d1 when the cutting tips 828 engage a surface of a work piece (not shown in FIG. 9). The cutting tips 828 are V-shaped, which will machine a V-shaped trough in every groove of depth d1 in the work piece. In the cutting tool 520, the cutting tips 528, 529 are separated by a distance of two pitches P, i.e. n=2 in the formula Y=nP, and Y=2P. Thus, the V-shaped trough grooves of depth d1 in the work piece will be separated by a distance 2P. The cutting tips 829 have a height h2, which is less than h1, which will create grooves with an identical cutting depth h2 when the cutting tips 829 engage a surface of a work piece. The cutting tips 829 are rounded, which will machine a rounded trough in every groove of depth d2 in the work piece. In the cutting tool 820, the cutting tips 829 are also separated by a distance of two pitches P, i.e. n=2 in the formula Y=nP, and Y=2P. Thus, the rounded trough grooves of depth d2 in the work piece will also be separated by a distance 2P.

In use, the tool 820 in FIG. 9 will be advanced a distance of 2(2P)=4P for each revolution of the work piece, and the resulting groove pattern will include V-shaped trough grooves with a depth d1 a distance 2P apart, each separated by a rounded trough groove with a depth d2. The rounded trough grooves will also be separated by a distance 2P.

In yet another example shown in FIG. 10, a portion of a cutting tool 920 includes a tool mounting structure 924 with tool shanks 922, 923 and 925A-C. Each tool shank 922, 923, 925 includes a cutting tip 928, 929 and 931A-C, respectively. The cutting tips 928, 929 each have a height h1, which will create grooves with an identical cutting depth d1 when the cutting tips 928, 929 engage a surface of a work piece (not shown in FIG. 10). The cutting tips 928, 929 include a flat tip with a width d3, which will machine a flat trough a distance d3 wide at the bottom of every groove of depth d1 in the work piece. In the cutting tool 920, the cutting tips 928, 929 are separated by a distance of 4 pitches P, i.e. n=4 in the formula Y=nP, and Y=4P. Thus, the rounded trough grooves of depth d1 in the work piece will be separated by a distance 4P. The cutting tips 931A-C have a height h2, which is less than h1, which will create grooves with an identical cutting depth h2 when the cutting tips 931A-C engage a surface of a work piece. The cutting tips 931A-C are rounded, which will machine a rounded trough in every groove of depth d2 in the work piece. In the cutting tool 920, the cutting tips 931A-C are separated by a distance of one pitch P, i.e. n=1 in the formula Y=nP, and Y=P. Thus, the rounded trough grooves of depth d2 in the work piece will also be separated by a distance P.

In use, the tool 920 will be advanced a distance of 2(4P)=8P for each revolution of the work piece, and the resulting groove pattern will include flat trough grooves with a depth d1 a distance 4P apart, each separated by three rounded trough grooves with a depth d2. The rounded trough grooves will be separated by a distance P. Optical films including structural patterns of ribs and lenticular elements corresponding to this groove pattern have excellent adhesion to adjacent films in optical display devices.

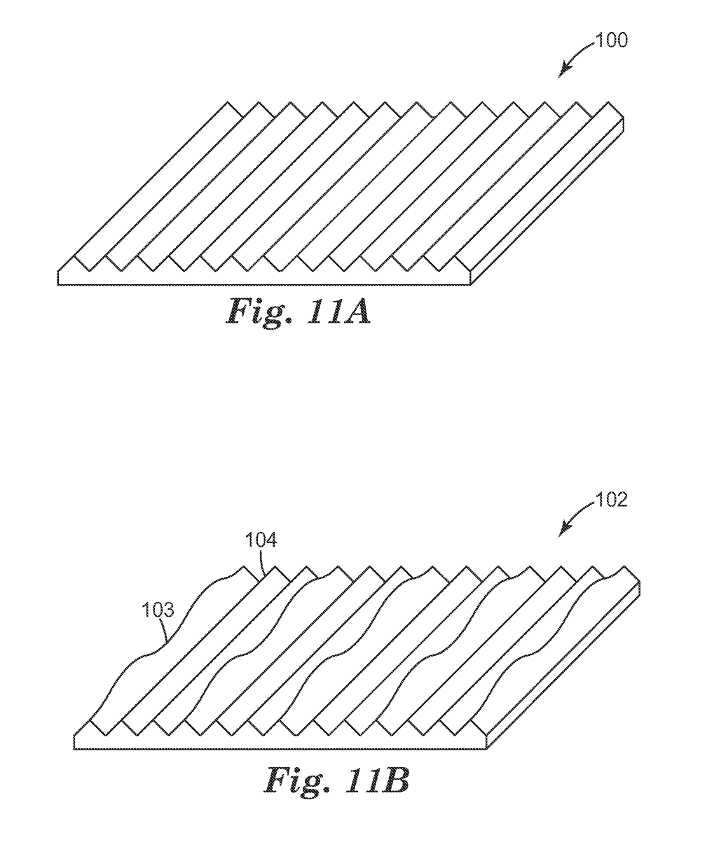

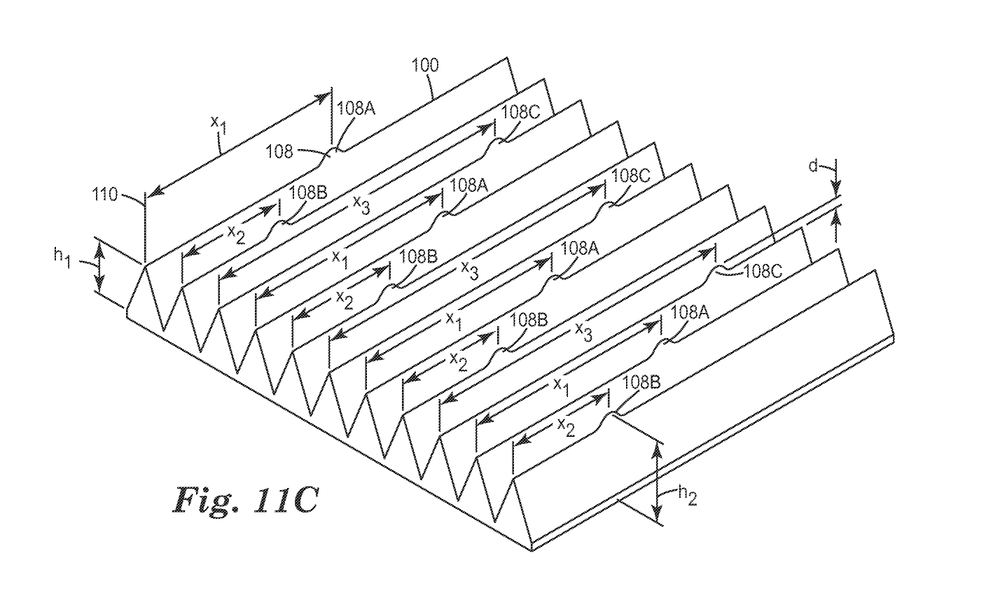

Multi-tipped tools may also be used in combination with thread and plunge cutting to provide microreplication tools with a unique pattern, which can create an optical film with desired optical effects. For example, assume the cutting tool 320 shown in FIG. 5A is used in a thread cutting procedure as described in detail in FIGS. 5B-5F to machine a grooved work piece. In one embodiment, the work piece can be a casting roll, which can be used to produce an optical film with an array of raised rib-like structures corresponding to the groove pattern in the roll. The ribs have a substantially constant height, and an example of such an optical film 100 is illustrated in FIG. 11A.

However, assume that the casting roll is machined with the tool 320 of FIG. 5A, but the tool 320 is vibrated by a fast tool servo. In one embodiment, the resulting optical film would have an appearance like the film 102 of FIG. 11B, including undulating pairs of undulating (varying height) grooves 3P apart, each separated by 2 V-shaped grooves of substantially constant height. Each of the substantially constant height grooves is P apart.

In yet another embodiment shown in FIG. 11C, again assume the casting roll is machined with the tool 320 of FIG. 5A, which can create an optical film 106 having an array of ribs, each with a first region 107 of substantially constant height h1. However, at a selected interval (which could be regular, pseudo-regular or random), the tool 320 is plunged a distance d further into the work piece to form on each rib at least one second region 108 with a height h2=h1+d. Since the cutting tips on the tool 320 are a distance 3P apart, the second regions 108 on every third rib will be in linear registration, i.e. substantially the same distance from a reference point such as, for example, an edge of the film. However, the two ribs between each pair of third ribs will have second regions that are not in linear registration with the ribs on the third rib pairs (or the ribs between the third rib pairs may even have no second regions at all). For example, in FIG. 11C, the second regions 108A are a distance x1 from a reference point 110 at the film edge, the second regions 108B are a distance x2 from the reference point 110, and the second regions 108C are a distance x3 from the reference point 110, with x1≠x2≠x3. Such an arrangement of second regions reduces or substantially eliminates wet out, while substantially preserving the optical gain of the film when the film is used in a display device.

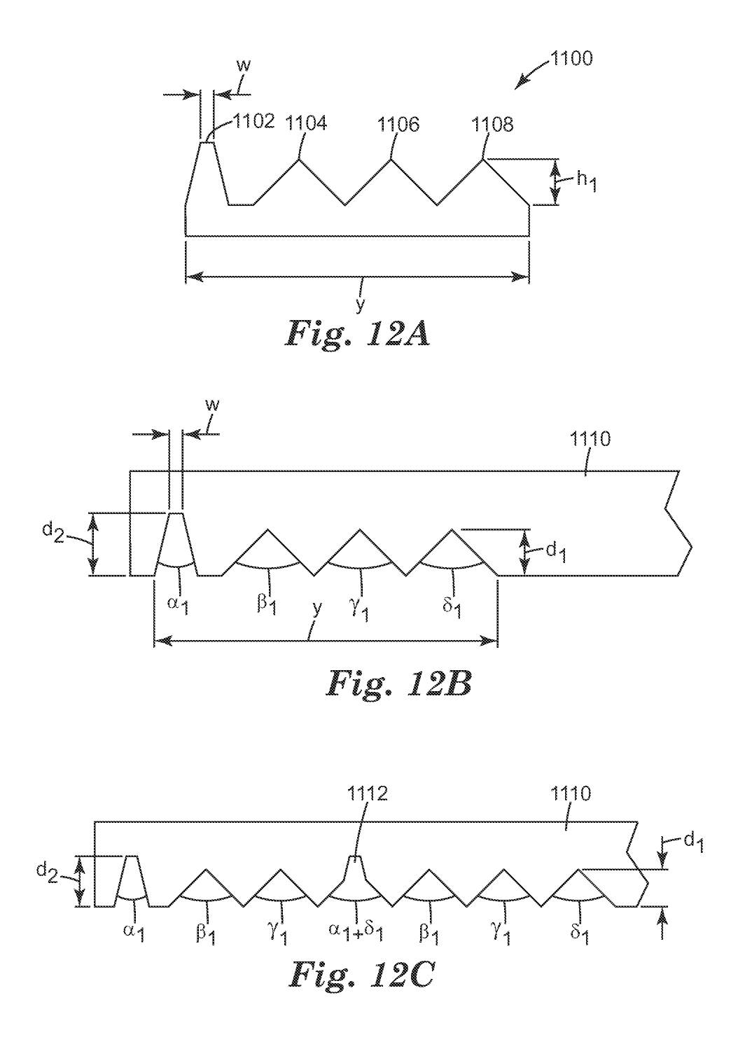

Another cutting tool 1100 is shown in FIG. 12A, which includes multiple cutting tips 1102, 1104, 1106 and 1108. The cutting tips 1104, 1106, 1108 have a height h1, while cutting tip 1102 has a height h2>h1. The cutting tip 1102 also includes a flat cutting region with a width w, and the total width of the cutting tool is Y.

Referring to FIG. 12B, a first cutting pass with the cutting tool 1100 produces in a substrate 1110 three substantially identical grooves β1, γ1, δ1 with V-shaped cross-sections and a depth d1, with groove β1 cut by cutting tip 1104, groove γ1 cut by cutting tip 1106, and groove δ1 cut by cutting tip 1108. The cutting tip 1102 on the cutting tool 1100 produces a generally V-shaped groove α1 with a flat “floor” of width w and a depth d2>d1.

Referring to FIG. 12C, in a second cutting pass the cutting tool 1100 is advanced a lateral distance Y equal to the entire width of the tool 1100. In the second cutting pass the cutting tip 1102 cuts into existing groove δ1 and adds a flat floored region 1112 with a depth d2. The resulting groove includes features of both original grooves α1 and δ1, and the second cutting pass creates a composite groove with an additive structure of the first cutting tip 1102 and the last cutting tip 1108 on the cutting tool 1100. In the second cutting pass the cutting tips 1104, 1106 and 1108 also create V-shaped grooves β2, γ2, δ2, respectively, each having a depth d1. In a subsequent cutting pass, the cutting tool 1100 will again be advanced a lateral distance Y, and, not counting the first groove α1, the flat-floored structure will be added into every third groove δn.

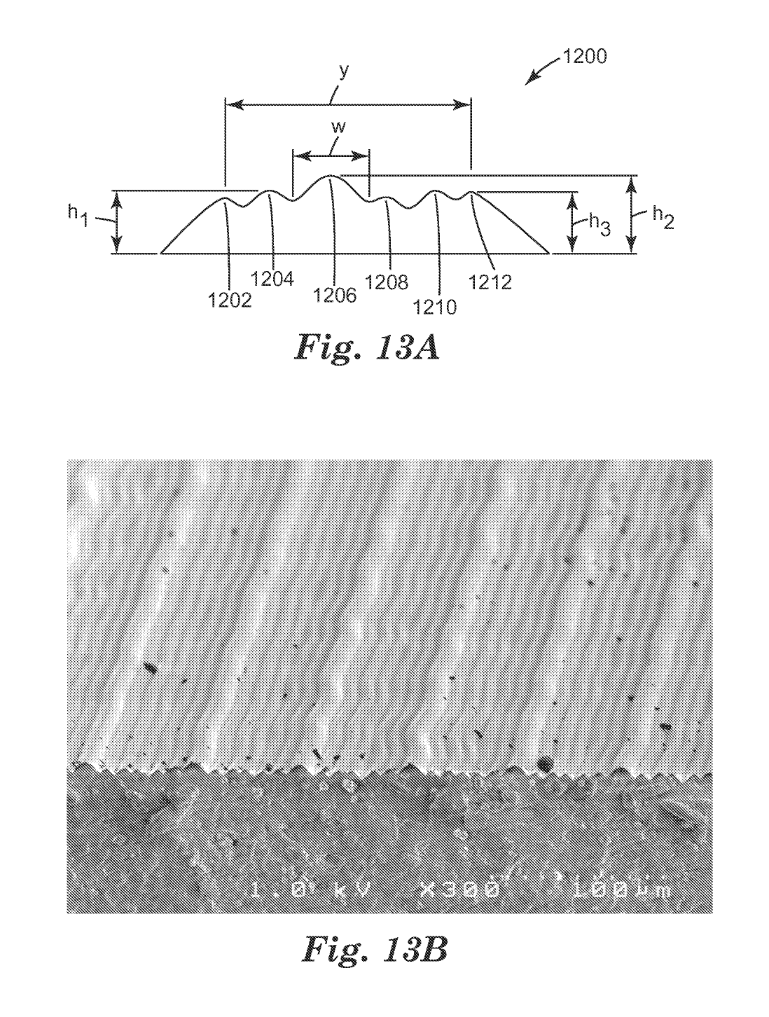

FIG. 13A is a cross-sectional view of a cutting tool 1200 that includes 6 cutting tips 1202, 1204, 1206, 1208, 1210, and 1212, each having a different shape, width and height. For example, the cutting tool 1204 has a height h1, while cutting tip 1206 has a height h2>h1. The cutting tip 1212 has a height h3<h1<h3. Of all the cutting tips in the cutting tool 1200, the cutting tip 1206 has the greatest overall width w. The overall width of the cutting tool 1200 is Y.

FIG. 13B is a photomicrograph of a potting material, which shows a pattern created when the tool 1200 was used in a multi-start cutting process as described herein. In a first cutting pass, the cutting tips 1202, 1204, 1206, 1208, 1210 and 1212 create respective grooves 1302, 1304, 1306, 1308, 1310 and 1312 respectively. In a second cutting pass, the cutting tool 1200 is advanced a distance Y equal to the entire width of the tool to create a second arrangement of grooves where cutting tip 1202 creates groove 1322, cutting tip 1204 creates groove 1324, cutting tip 1206 creates groove 1326, cutting tip 1208 creates groove 1328, cutting tip 1210 creates groove 1330, and cutting tip 1212 creates groove 1332. Using this cutting technique, the cutting tip 1200 forms a unique groove shape in every sixth groove.

As noted above, the present invention is applicable to display systems and is believed to be particularly useful in reducing cosmetic defects in displays and screens having multiple light management films, such as backlit displays and rear projection screens. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A method for cutting a pattern in a work piece, wherein the pattern comprises adjacent features separated by a pitch spacing P, the method comprising:
providing a cutting tool assembly comprising a first tool shank with a first cutting tip to create a first feature in the work piece and a second tool shank with a second cutting tip to create a second feature in the work piece, wherein a distance Y between the first cutting tip and the second cutting tip is equal to nP, and wherein n is an odd integer greater than 1,
rotating the work piece with respect to the cutting tool assembly, and
advancing the cutting tool along a lateral direction with respect to the rotating work piece, wherein the cutting tool is advanced along the lateral direction a distance of 2P for each rotation of the work piece.

2. A method for cutting a pattern in a work piece, wherein the pattern comprises adjacent features separated by a pitch spacing P, the method comprising:
providing a cutting tool assembly comprising a first tool shank with a first cutting tip to create a first feature in the work piece and a second tool shank with a second cutting tip to create a second feature in the work piece, wherein a distance Y between the first cutting tip and the second cutting tip is equal to nP, and wherein n is an even integer;
rotating the work piece with respect to the cutting tool assembly;
beginning at a starting position, advancing the cutting tool along a lateral direction with respect to the rotating work piece, wherein the tool is advanced along the lateral direction a distance of 2Y for each rotation of the work piece;
returning the cutting tool to the starting position and advancing the cutting tool a distance P along the lateral direction to an offset starting position; and
beginning at the offset starting position, advancing the cutting tool along the lateral direction with respect to the rotating work piece, wherein the cutting tool is advanced a distance of 2Y for each rotation of the work piece.

3. A method for cutting a pattern in a work piece, wherein the pattern comprises adjacent features separated by a desired pitch spacing P and a maximum acceptable departure Δ from P, the method comprising:
providing a cutting tool assembly comprising a first tool shank with a first cutting tip to create a first feature in the work piece and a second tool shank with a second cutting tip to create a second feature in the work piece;
setting a distance a distance Y=nP between the first and second cutting tips, wherein n is an integer greater than ε/Δ, and wherein ε is an accuracy in achieving a desired spacing between the first and second cutting tips;
measuring an actual distance S between the first and second cutting tips;
rotating the work piece with respect to the cutting tool assembly; and
advancing the cutting tool along a lateral direction with respect to the rotating work piece, wherein the cutting tool is advanced along the lateral direction a distance of 2P′ for each rotation of the work piece, wherein P′=S/n.

4. A light directing film, comprising:
a structured major surface comprising an array of rows of linear microstructures extending along a first direction, wherein
each linear microstructure in the array comprises a plurality of first regions with constant heights and a plurality of second regions with maximum heights greater than the constant heights of the plurality of first regions;
wherein the second regions of any two linear microstructure n rows apart are in linear registration with each other but not with the second regions of the in between linear microstructures, n being greater than 2.

5. The light directing film of claim 4, wherein the first and second regions in at least some of the linear microstructures have the same lateral cross-sectional shape.

6. A method for cutting a pattern in a work piece, the method comprising:
providing a cutting tool assembly comprising a plurality of cutting tips, wherein the cutting tips have a non-constant height, wherein a distance between the cutting tips P is non-constant, and wherein the cutting tool assembly has a width Y;
rotating the work piece with respect to the cutting tool assembly, and
advancing the cutting tool along a lateral direction with respect to the rotating work piece, wherein the cutting tool is advanced along the lateral direction a distance of Y for each rotation of the work piece.
